(19) United States
(12) Patent Application Publication
(10) Pub. No.: US 2019/0133291 A1
(43) Pub. Date: May 9, 2019

(54) LICE COMB CLEANING APPARATUS AND A CLEANING METHOD

(71) Applicant: Aharon KRISHEVSKI, Beit Shemesh (IL)

(72) Inventor: Aharon KRISHEVSKI, Beit Shemesh (IL)

(21) Appl. No.: 16/186,548

(22) Filed: Nov. 11, 2018

Related U.S. Application Data
(63) Continuation-in-part of application No. 15/610,657, filed on Jun. 1, 2017, now abandoned.

(51) Int. Cl. A45D 24/30; B08B 1/00; A45D 24/10

(52) U.S. Cl. CPC A45D 24/30; A45D 24/10; B08B 1/006; B08B 1/007

(57) ABSTRACT

A method for cleaning teeth of a lice comb, the method comprising the steps of: providing a cleaning pad (14); applying said teeth (12) into said cleaning pad (14); brushing hair while said teeth (12) are applied into said cleaning pad (14), for filtering lice and eggs by said lice comb teeth; and removing said cleaning pad from said comb, thereby removing lice and eggs filtered by said cleaning pad; wherein said cleaning pad comprises deformable material for gripping each of the comb's teeth around, thereby preventing from lice and eggs to pass through said cleaning pad.

### TECHNICAL FIELD

The invention relates to the field of combs. More particularly, the invention relates to a lice comb cleaning apparatus, and a cleaning method.

### BACKGROUND

A lice comb includes a body and teeth extending therefrom. The teeth of a lice comb are denser in comparison to a hair brushing comb, for picking out lice, eggs, and other undesirable matter.

The lice comb, particularly when used for picking lice, must be cleaned after use. This is performed by hand, paper, flowing water or other means.

Since all these means are external to the comb, and unaesthetic, lice combing is a nasty activity.

There is a long felt need to provide a solution to the above-mentioned and other problems of the prior art.

### SUMMARY OF THE INVENTION

The present invention is directed to a method for cleaning teeth of a lice comb, the method comprising the steps of:
providing a pad (14);
applying the teeth (12) into the pad (14);
brushing hair of a user while the teeth (12) are applied into the pad (14), for filtering lice and eggs by the lice comb teeth; and
removing the pad from the comb, thereby removing lice and eggs filtered by the pad;
wherein the pad comprises deformable material for gripping each of the comb's teeth around, thereby preventing from lice and eggs to pass through the pad.

The deformable material may be a woven fabric, a non-woven fabric, a stretchable fabric, a stretchable material, rubber, nylon, plastic, silk, and the like.

According to one embodiment of the invention, the deformable material comprises a hook-and-loop fastener attached to the area in which teeth of a lice comb are integrated, for preventing of lice and eggs to fall out of the lice comb.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments, features, and aspects of the invention are described herein in conjunction with the following drawings:

FIG. 1 depicts a lice comb cleaning apparatus, according to one embodiment of the invention.

FIG. 2 depicts the lice comb cleaning apparatus of FIG. 1, at the first step of use.

FIG. 3 depicts the lice comb cleaning apparatus of FIG. 1 at the second step of use.

FIG. 4 depicts the lice comb cleaning apparatus of FIG. 1 at the third step of use.

FIG. 5 depicts the lice comb cleaning apparatus of FIG. 1 according to another embodiment.

FIG. 6 pictorially illustrates a lice comb, according to the prior art.

FIG. 7 schematically illustrates a cleaning pad 14, according to one embodiment of the invention.

FIG. 8 schematically illustrates a cleaning pad 14, in which a lice comb 40 is integrated, according to one embodiment of the invention.

FIG. 9 schematically illustrates a cleaning pad, having a hook-and-loop fastener attached to the area in which teeth of a lice comb are integrated, according to one embodiment of the invention.

FIG. 10 pictorially illustrates a lice comb, according to the prior art.

FIG. 11 pictorially illustrates a lice-comb cleaning pad, according to one embodiment of the invention.

FIGS. 12 to 16 pictorially illustrate a combing and cleaning process, according to one embodiment of the invention.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

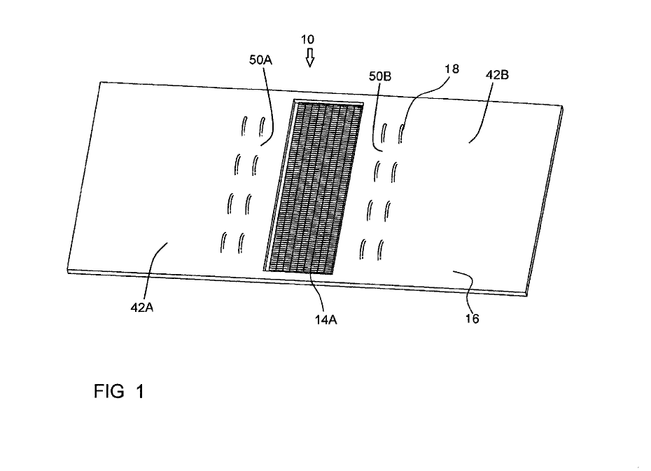

FIG. 1 depicts a lice comb cleaning apparatus, according to one embodiment of the invention.

A lice comb cleaning apparatus 10 includes a fabric or sieve 14A; a board 16; and stitches 18 for connecting ends 50A and 50B of (hidden in the figure) fabric 14A to board 16, for allowing holding fabric 14A by board 16.

According to a preferred embodiment, board 16 includes two regions 42A and 42B, each for being held by one hand of the user, such that fabric 14A is disposed between regions 42A and 42B and not covered thereby.

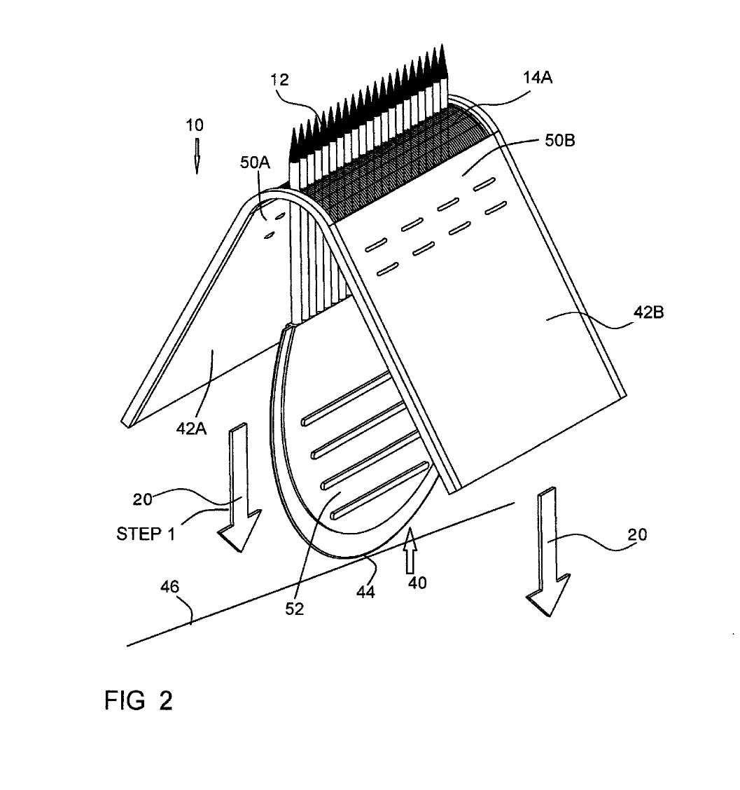

FIG. 2 depicts the lice comb cleaning apparatus of FIG. 1, at the first step of use.

At the first step, the user holds region 42A of board 16 with a first hand; holds region 42B with a second hand; places fabric 14A on the teeth 12 of a lice comb 40; and presses each of regions 42A and 42B parallel to teeth 12 and therealong, as shown by arrow 20, towards the handle 52 of lice comb 40, while the bottom 44 of handle 52 is supported, e.g., by rests a table.

The above operation provides significant force of drawing away ends 50A and 50B of fabric 14A one from the other, thus it stretches fabric 14A, and further presses fabric 14A onto teeth 12, such that teeth 12 perforate fabric 14A, thereby threading themselves therethrough.

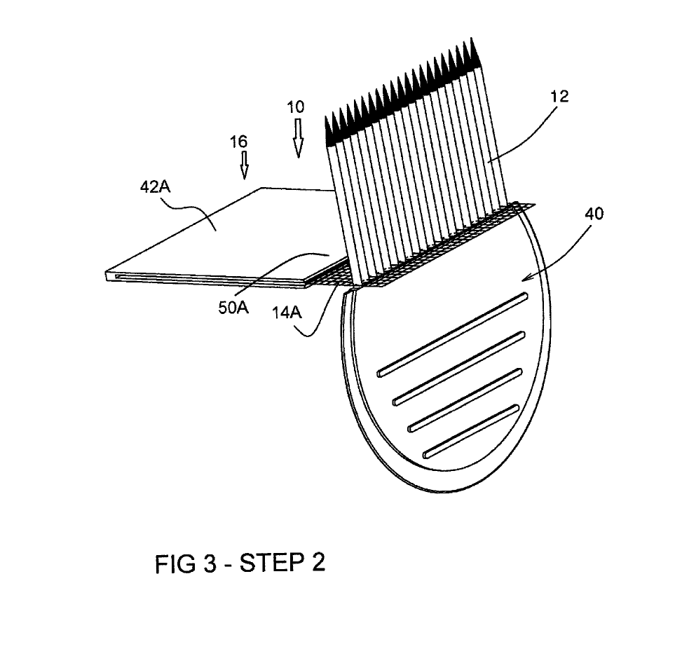

FIG. 3 depicts the lice comb cleaning apparatus of FIG. 1 at the second step of use.

At the second step of use, the user places lice comb cleaning apparatus 10 at the end of teeth 12, and may comb the hair.

FIG. 3 shows an embodiment of lice comb cleaning apparatus 10 having one region 42A of board 16.

FIG. 4 depicts the lice comb cleaning apparatus of FIG. 1 at the third step of use.

At the third step, the user lifts any of regions 42A or 42B, as shown by arrow 24, and further pulls comb cleaning apparatus 10, for removing it from comb 40, thereby removing the lice from teeth 12.

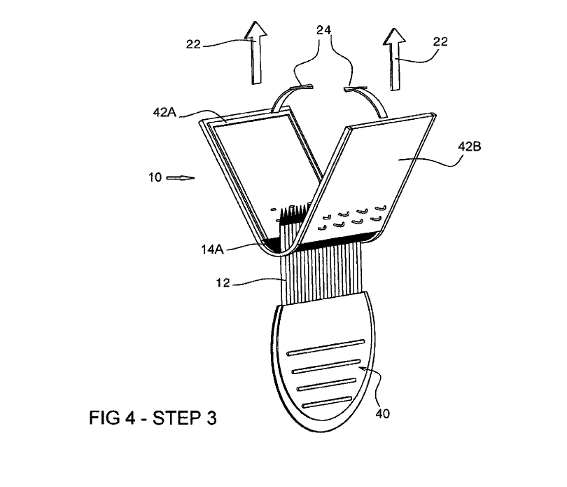

FIG. 5 depicts the lice comb cleaning apparatus of FIG. 1 according to another embodiment.

Lice comb cleaning apparatus 10 may further include a fabric 14B, being removably stuck to fabric 14A.

Accordingly at the third step, the user may lift fabric 14A with board 16 from teeth 12, while holding fabric 14B for not allowing removal thereof, thus separating fabric 14A only, with the dirt, from teeth 12 and from fabric 14B.

Then, the user may again comb the hair.

Lice comb cleaning apparatus 10 may further include a fabric 14C, being removably stuck to fabric 14C.

Then, the user may lift fabric 14B alone from teeth 12, while holding fabric 14C for not allowing removal thereof, thus separating fabric 14B only from teeth 12 and from fabric 14C.

Thus, in one aspect, the invention is directed to a lice comb cleaning apparatus (10), including:
a board (16), for being held by a user's hand; and
a first fabric (14A), at least one end (50A) thereof attached to the board (16),
thereby allowing, by holding the board (16), to thread teeth (12) of a lice comb (40) into the first fabric (14A), for later removing the first fabric (14A) therefrom, thereby cleaning the teeth (12) by the first fabric (14A).

The at least one end (50A) of the first fabric (14A), being attached to the board (16), may include at least two ends (50A, 50B) of the first fabric (14A) being attached to the board (16), thereby forming two regions (42A, 42B) of the board (16), each of being held by a different hand, for allowing forcible pressing, by the hands, the first fabric (14A) onto the teeth (12), for applying the threading thereof into the first fabric (14A).

The lice comb cleaning apparatus (10) may further include:
a second fabric (14B), being removably stuck to the first fabric (14A),
thereby the threading of the teeth (12) into the first fabric (14A) threads the teeth (12) into the second fabric (14B) as well, and
thereby upon the later removing of the first fabric (14A), allowing leaving the second fabric (14B) on the teeth (12), thereby allowing further cleaning the teeth (12) by the second fabric (14B).

The lice comb cleaning apparatus (10) may further include:
a third fabric (14C), being removably stuck to the second fabric (14B),
thereby the threading of the teeth (12) into the first fabric (14A) threads the teeth (12) into the third fabric (14C) as well, and
thereby allowing removing the second fabric (14B), for leaving the third fabric (14C) on the teeth (12).
thereby allowing further cleaning the teeth (12) by the third fabric (14C).

The attaching of the first fabric (14A) to the board (16) may constitute stitching, for provide strong force of the attaching.

The material of the board (16) may be paperboard, thereby allow the stitching.

According to one embodiment of the invention, the board comprises a hook-and-loop fastener, such as of Velcro®. This allows attaching the 42A and 42B parts of the board to each other while combing.

According to one embodiment of the invention, the fabric is stretchable. A stretchable fabric surrounding each of the teeth of a comb better “filters” lice and eggs.

According to one embodiment of the invention, the fabric is of a non-woven form. A non-woven fabric does not comprise crisscross fibers, and accordingly better seals the surrounding of each tooth of a comb.

A Cleaning Pad

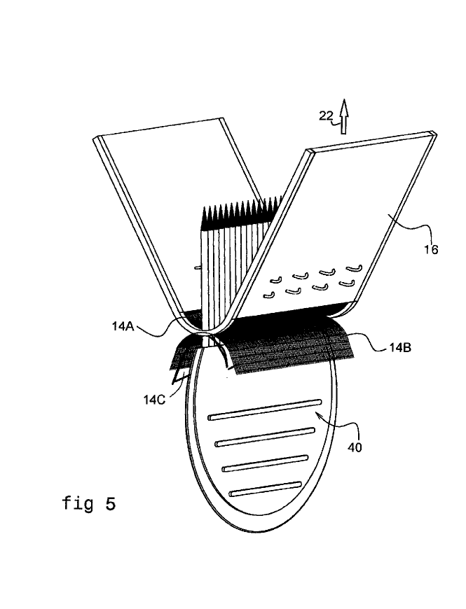

FIG. 6 pictorially illustrates a lice comb, according to the prior art.

The lice comb comprises teeth 12 fixed in a base 52 which is used also as a handle for holding the comb while cleaning lice and eggs from hair.

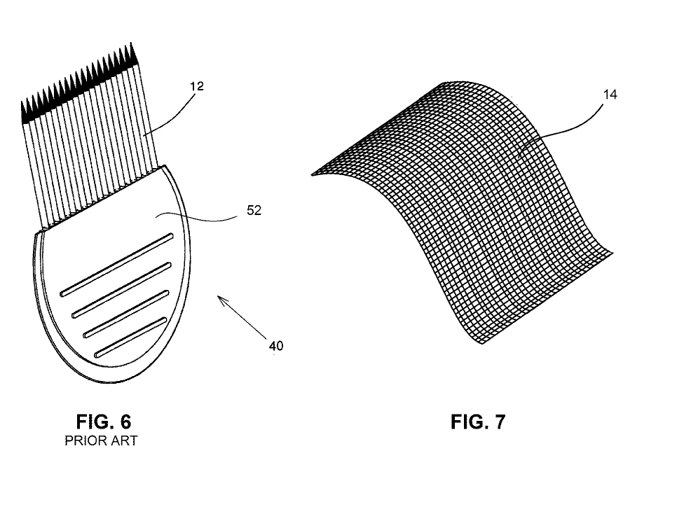

FIG. 7 schematically illustrates a cleaning pad 14, according to one embodiment of the invention.

FIG. 8 schematically illustrates a cleaning pad 14, in which a lice comb 40 is integrated.

Lice combs of the prior art contain dense teeth, for the purpose that all lice and eggs are trapped by its teeth, like fish in fishing net. Nevertheless, after cleaning, lice and eggs still remain on the teeth of the lice comb. Since a lice comb is preferably not disposable, there is a long felt need to find a solution for using a lice comb several times.

The solution described in FIGS. 7-9 is a pad to be applied to the teeth of a lice comb before cleaning, and removed from the comb along with the lice and eggs of trapped in the comb and pad upon ending the cleaning. Such a pad may be disposed after a single use, but allows using the comb a plurality of times, even hundreds of times.

A basic requirement from the pad is that lice and eggs cannot pass through its fibers. For this purpose the spaces between the pad fibers should be smaller than the size of the lice and eggs so that they cannot pass through the pad.

A second feature that can prevent lice and eggs from passing through the pad is the grip of the padding around each of the teeth of the comb. A stretchable fabric will do since it seals spaces between the pad fibers and comb teeth so that lice and eggs cannot pass through the spaces.

Additionally or alternatively, a non-woven fabric will also do, since in contrast to a crisscross fabric the gaps between its fibers have no corners, so a rounded cross-section comb tooth is gripped all over its extent.

But even if the pad absolutely prevents the passage of lice and eggs through it, the eggs and lice must still be prevented from falling off the comb and pad during and after the combing. This is can be prevented by a fastener which surrounds the area where the comb teeth is applied. An example of a hook-and-loop fastener is a Velcro fastener.

As mentioned, the cleaning pad 14 may be made of a stretchable (elastic) material. An example of such material is a Lycra fabric. “Spandex, Lycra or elastane is a synthetic fiber known for its exceptional elasticity.” (From Wikipedia) Using a stretchable fabric such as Spandex causes the fabric to grip each of the teeth around and therefore prevent passage of lice and eggs through gaps in the pad around the comb's teeth.

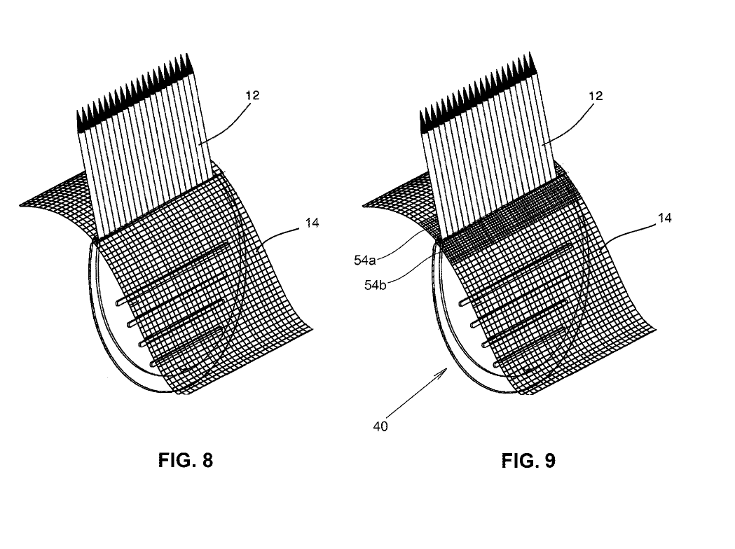

FIG. 9 schematically illustrates a cleaning pad 14, having a hook-and-loop fastener (elements 54a and 54b) attached to the area in which teeth 12 of a lice comb 40 are integrated.

Upon pulling the cleaning pad 14 out, after cleaning the fastener on one side of the teeth 54a can be fastened to the fastener on the other side of the teeth 54b, and as a result prevent from lice and eggs to fall out of the pad.

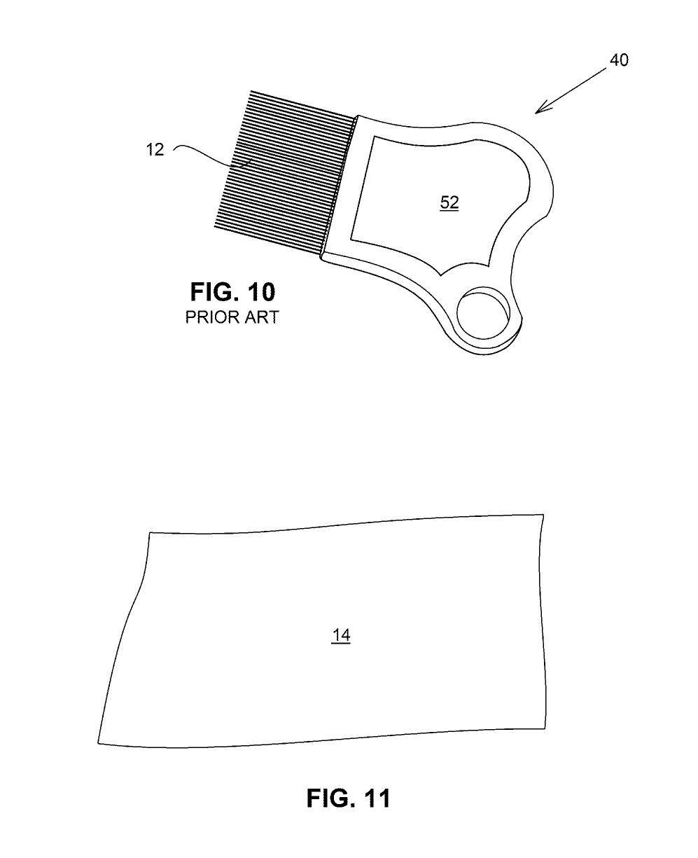

FIG. 10 pictorially illustrates a lice comb 40, according to the prior art.

The lice comb comprises a handle 52 to be held by a user while combing, and teeth 12.

FIG. 11 pictorially illustrates a lice-comb cleaning pad 14, according to one embodiment of the invention.

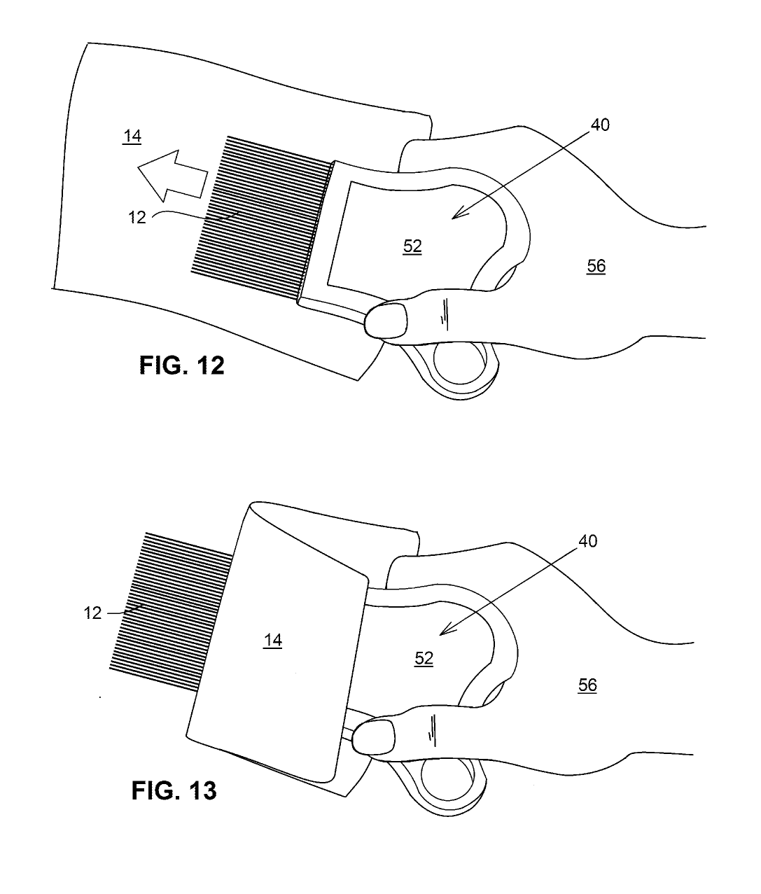

FIGS. 12 to 16 pictorially illustrate a combing and cleaning process, according to one embodiment of the invention.

In FIG. 12, a user hand 56 is integrating a lice comb 40 into a cleaning pad 14. The arrow illustrates the movement of the comb.

FIG. 13 pictorially illustrates the lice comb 40 and the cleaning pad 14 after the comb teeth have been integrated into the cleaning pad 14.

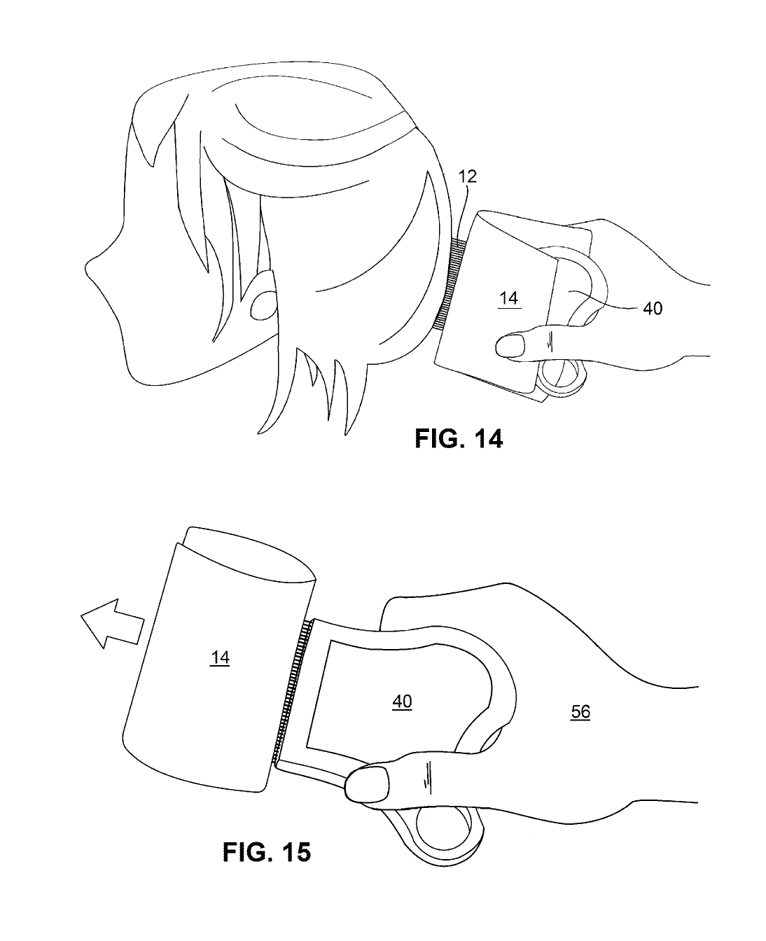

FIG. 14 pictorially illustrates a brushing process in which a user holds the comb 40 to which a cleaning pad 14 has been integrated, and brushes the hair of a user.

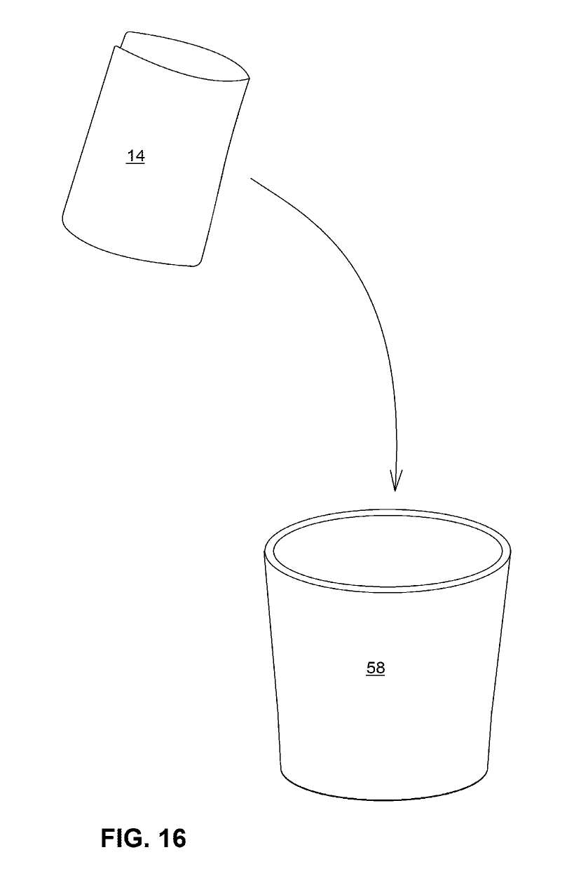

FIG. 15 pictorially illustrates a process in which a cleaning pad 14 is removed from the lice comb 14 along with lice and eggs. The arrow illustrates the removing direction.

FIG. 16 pictorially illustrates a combing process in which the used cleaning pad is thrown into a trash can 58.

In the figures and/or description herein, the following reference numerals (Reference Signs List) have been mentioned:
numeral 10 denotes the lice comb cleaning apparatus, according to one embodiment of the invention;
numeral 12 denotes the comb's tooth;
numeral 14 denotes a cleaning pad, which may be a fabric, a non-woven fabric, a stretchable fabric, stretchable material such as rubber, nylon, plastic, silk, and actually any deformable material which grips each of the comb's teeth around, thereby prevents lice and eggs to pass through it;
numeral 14A denotes the fabric stitched to the board;
numeral 14B denotes the fabric removeably attached to fabric 14A;
numeral 14C denotes the fabric removably attached to fabric 14B; additional fabrics may be removably attached;
numeral 16 denotes a board for holding the fabric; typically the material thereof is paperboard, for allowing stitching onto;
numeral 18 denotes a stitch;
numeral 20 denotes the direction of pulling the boards for pressing the fabric onto the comb's teeth;
numeral 22 denotes the direction of removing the fabric from the comb;
numeral 24 denotes the rotation and lifting of the board;
numeral 40 denotes the lice comb;
numerals 42A and 42B denote two regions of the board;
numeral 44 denotes the bottom of the lice comb's handle;
numeral 46 denotes a table;
numerals 50A and 50B denote ends of the fabric, being stitched to the board;
numeral 52 denotes the lice comb's base, which is used also as a handle;
each of numerals 54a and 54b denotes a hook-and-loop fastener;
numeral 56 denotes a user hand;
numeral 58 denotes a trash can.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A lice comb teeth cleaning method, comprising the steps of:
providing a cleaning pad (14);
applying said teeth (12) into said cleaning pad (14);
brushing hair while said teeth (12) are applied into said cleaning pad (14), for filtering lice and eggs by said lice comb teeth; and
removing said cleaning pad from said comb, thereby removing lice and eggs filtered by said teeth;
wherein said cleaning pad comprises deformable material for gripping each of the comb's teeth around, thereby preventing from lice and eggs to pass through said cleaning pad to other side thereof upon said removing said pad.

2. A method according to claim 1, wherein said deformable material comprises a woven fabric.

3. A method according to claim 1, wherein said deformable material comprises a non-woven fabric.

4. A method according to claim 1, wherein said deformable material comprises a stretchable fabric.

5. A method according to claim 1, wherein said deformable material comprises stretchable material.

6. A method according to claim 1, wherein said deformable material comprises rubber.

7. A method according to claim 1, wherein said deformable material comprises nylon.

8. A method according to claim 1, wherein said deformable material comprises plastic.

9. A method according to claim 1, wherein said deformable material comprises silk.

10. A method according to claim 1, wherein said deformable material comprises a hook-and-loop fastener attached to the area in which teeth of a lice comb are integrated, for preventing of lice and eggs to fall out of said lice comb.
